(19) United States
(12) Patent Application Publication
(10) Pub. No.: US 2015/0183235 A1
(43) Pub. Date: Jul. 2, 2015

(54) METHOD FOR COATING PRINTED SURFACES

(71) Applicants: Pedro Garcia Merono, Torre Pacheco (ES); Javier Martin Muriel, Torre Pacheco (ES)

(72) Inventors: Pedro Garcia Merono, Torre Pacheco (ES); Javier Martin Muriel, Torre Pacheco (ES)

(73) Assignee: HDPB SYSTEM INTERNATIONAL, S.A., Obarrio (PA)

(21) Appl. No.: 14/402,173

(22) PCT Filed: Jun. 7, 2012
(86) PCT No.: PCT/ES2012/070424

§ 371 Date: Mar. 12, 2015

Related U.S. Application Data
(60) Provisional application No. 61/652,557, filed on May 29, 2012.

(51) Int. Cl. B41J 11/00

(52) U.S. Cl. CPC B41J 11/0015

(57) ABSTRACT

The invention relates to a method for coating any type of printed image, comprising the steps of a) printing an image on the surface of a substrate conventionally or digitally; b) applying at least one layer of a varnish product on the printed surface; c) sanding the surface to eliminate accumulations of material, impurities and other unwanted adhered elements; d) polishing the surface to eliminate imperfections; and e) glossing.

### OBJECT OF THE INVENTION

The present invention relates to a method for coating printed surfaces, particularly any type of surface on which photographs, drawings or any type of print are printed, which allows coating surfaces of any size and with different domestic, decorative and advertising applications in an automated manner and in series.

This invention applies in the field of conventional and digital printing for coating panels for decorative, advertising or other particular purposes, such as photographs, posters, signs, and prints of textures such as wood, metal, paper, etc.

### DESCRIPTION OF THE STATE OF THE ART

Different methods used for coating images, such as photographs or drawings, to protect them against external agents, to prevent light from maximally affecting image quality over time, and to improve image quality with the glossiness of the photograph or drawing, are known in the state of the art.

It must be taken into account that the glossiness and enhancement of the image achieved with known means is not superior to the glossiness of the product coated according to the method of the present invention. On the other hand, the cost for coating or protecting the image must also be taken into account, it being necessary to achieve a balance between the results obtained and the investment made.

Some of the methods conventionally used for coating printed images, such as photographs or drawings, are gloss coat, plexiphoto and varnishing.

The gloss coat consists of applying an epoxy resin on any type of print, such that after the resin is applied and dried, the product is finished without any additional treatment. This coating does not allow subsequent abrasive treatment to eliminate possible impurities or air bubbles since the surface would be damaged by the characteristics of the resin.

Plexiphoto or plexiglass consists of adhering a print to a plastic or glass material, which must be transparent, in the rear part of the plane or substrate, such that this plastic material protects the image. This material is in no case subsequently treated with abrasive means. In this method, since the material is placed in the rear part, it must be transparent, so the method cannot be performed using other opaque substrates.

For varnishing a print, a thin layer of varnish is usually applied by the same printer responsible for printing the image on the substrate. This system is carried out with a UV (ultraviolet) technique, no additional treatment being performed subsequently. Another alternative method is to apply varnish with a brush or the like or by spraying, but no additional treatment is performed after this process either. Generally, in known varnish application systems the purpose of varnish is to give the impression of glossiness, but none of said systems obtains a result having the hardness, glossiness and definition obtained by means of the present invention.

The present invention has the following advantages with respect to the systems of the state of the art described above:
Cost reduction as a result of process automation with respect to gloss coat.
Improvement in the perception of uniformity and fusion of the image with the coating, as well as being smoother due to the treatments applied, with respect to gloss coat in which there are bubbles and imperfections.
Applicability to any type of surface with respect to plexiglass. definition with respect to varnishing.
Possibility of repairing damage on the surface, mainly with respect to plexiglass and gloss coat.

In summary, there is no current coating technique which has all the advantages of the present invention. Likewise, none of the known techniques offers a result in which, visually, the printed image seems to be integrated in the coating such that the visual perception is that the coating is part of the print. This result is achieved with the present invention. In known techniques, the existence of the coating is observed as the difference between the surface and said coating can be perceived, whereas in the present invention the surface and the coating appear to form a single element.

The fact that none of the means known for coating surfaces allows repairing the coated surface in the event that said surface is damaged, an action which is possible by means of the method of the present invention, must be highlighted.

Therefore, the present invention proposes a method for coating surfaces printed either with photographs or other motifs, which allows overcoming the drawbacks existing in the known means. The present invention is the only invention which brings together a series of steps and techniques not contemplated by any other existing solution, primarily due to the fact that the method of the present invention, after each of the applied layers of varnish, subsequently proceeds to sanding and polishing said varnish in order to clean out impurities and to achieve uniformity over the entire surface of the printed image, thus achieving greater definition and glossiness in the image as well as greater hardness and glazing effect of said layer on the image. As will be described below, glossing is then performed to improve glossiness, both the image and the applied layers of varnish look as if they were of a single polished and glazed element.

### DESCRIPTION OF THE INVENTION

The method for coating printed surfaces object of this invention therefore allows coating prints in series achieving a shiny finish, enhancing the glossiness of the conventional or digital print, and achieving high durability.

The object of the present invention is therefore a method according to claim 1, comprising the following steps:
Printing an image, which will preferably be a photograph, a drawing, a text, or a composition comprising the aforementioned elements on the surface of a substrate,
Applying at least one layer of a varnish product on the surface of the image, photograph, printed drawing, or any type of print,
Sanding the surface to eliminate accumulations of material, impurities and other unwanted adhered elements,
Polishing the surface to eliminate imperfections and achieve greater surface uniformity, and
Glossing to enhance glossiness.

For printing the image, different substrate surfaces, such as paper, wood, aluminum, different types of plastic, etc., in summary, any substrate on which printing can be performed or which can be treated to subsequently perform printing thereon, can be used.

Printing on the substrate can be performed by following different methods, and with an indefinite number of passes per cm² depending on the necessary print quality. Likewise, said printing, depending on its type, will require one component or another, as well as different drying needs depending on the material of the substrate and on the environmental conditions, which obviously can also be modified as needed. The type of printing, which can be digital or conventional, as well as other known types of printing, is not an object of the present invention.

Once the printing is performed, at least one printed surface protective layer is applied by means of applying a transparent, preferably colorless, varnish with a high solid content, i.e., solid body makes up more than 50%, and preferably more than 60%, of the varnish. The applied varnish can incorporate a catalyst and a diluent. This product allows protecting, increasing the hardness, and accentuating the glossiness of the print made on the substrate. This layer or these layers are preferably applied by microspraying the varnish to prevent bubbles on the surface, on the substrate with the print, and suitably diluted depending on the requirements of the product, if required. Said layer must be thick enough to be subsequently treated with abrasive techniques.

Next, and once the varnish dries and hardens, it is sanded to eliminate air bubbles, accumulations of material, impurities and unwanted adhered elements, such as dust and other particles existing in the work area, that have been applied on the print together with the varnish. Sanding the surface also serves as a preparation for the subsequent polishing step. Said sanding is performed with different sandpapers depending on the result to be obtained and on the thickness of the previously applied layer or layers of varnish.

The two preceding steps can be repeated as many times as needed, such that another layer of varnish, which is subsequently polished, can be applied after sanding.

Once sanded, the surface is polished to remove any imperfection, such as lumps or accumulations of material, and to thus obtain maximum glossiness and enhancement of the print made. Along with this polishing, it is possible to incorporate different polishing creams as well as different surface protective materials depending on the intended application of said image. Glossing the surface is suitable for enhancing glossiness.

It must be pointed out that the different steps are performed in an automated manner by means of known machinery for the purpose of achieving uniformity both when applying the varnish and when sanding or polishing. Worker involvement is thus reduced to a minimum or completely eliminated in order to prevent manual handling of the products, thus reducing possible imperfections and the manufacturing cost.

The glossiness of the surface stands out due to the transparency and glossiness characteristics of the varnish in combination with the other steps of the method, such as eliminating impurities by means of sanding, obtaining greater uniformity due to polishing and, finally, glossing. The greater glossiness obtained and the impression of the image and the coating being a single element results from the joint application of all the steps.

As mentioned, it is possible to repeat the method after sanding the surface, reapplying at least one layer of varnish and sanding it. This step can be repeated as many times as needed such that the coating will become thicker. A second object of the invention is the product obtained after coating, i.e., a coated printed surface, comprising a frame, a layer corresponding to an image printed on the frame and at least one layer of a varnish with a high solid content on the printed image.

### DESCRIPTION OF A PREFERRED EMBODIMENT

A preferred embodiment of the present invention is described below, said invention comprising the following steps:
Printing a photograph or drawing on the surface of a substrate,
Applying at least one layer of a varnish product on the surface of the printed photograph or drawing,
Sanding the layer applied to eliminate accumulations of material, impurities and other unwanted adhered elements as well as to smoothen the surface,
Polishing the sanded surface to eliminate imperfections and for greater uniformity, and
Glossing to enhance and achieve glossiness of the image.

Before printing on the substrate, it will be necessary to choose the substrate on which the printing will be performed, and to decide if there is a need to condition said substrate.

In this embodiment, the images will be printed on an MDF (Medium Density Fibreboard) frame or substrate. MDF is a medium density substrate having wood fibers bonded together with synthetic resins by means of applying high pressure and heat, under dry conditions, until achieving medium density. Therefore, it has a uniform and homogeneous structure with a fine texture that allows a perfect finish on faces and edges. This material can be worked on in a manner virtually identical to solid wood, being able to be milled and cut entirely, its dimensional stability exceeding even than that of wood.

The dimensions of said substrates can be as follows:
Measurements 2050×3660×10 mm
Measurements 2050×3660×16 mm
Measurements 2050×3660×19 mm

The first step of the method which will be performed once the substrate or frame is chosen and adapted by means of sanding and polishing to eliminate possible imperfections on the material, is the digital photographic printing of the image, preferably a photograph or drawing, on said substrate. Said printing is performed by means of automatic ink printing machines in multiples passes followed by breaks for stabilizing and cooling the inks.

In this example, a machine having at least 5 colors, specifically a SIGMAJET machine, capable of providing 10 passes of color per cm², is used for printing the photograph. The inks used for printing the photograph on the substrates are solvent-based inks, such that they can be dried by means of UV lamps with an output of 3000 W or the like. Likewise, it is necessary to continue this step of the method with a phase for stabilizing and cooling the inks for a period of about 6 hours.

Said printing must be dried under environments with controlled humidity and temperature, in order to suitably stabilize and cool the inks used.

Subsequently, and once the ink dries, two layers of a varnish product with a high solid contents are applied by means of microspraying. A machine consisting of a Venjakot robot is used for said application, the spraying being performed by means of pressurized air using Kremlin equipment with a 14/174 nozzle.

The varnish used in this example is mixed with a synthetic hardening catalyst and with diluent, such that 20% of varnish, 50% of catalyst and 30% of diluent are incorporated per liter of varnish product to provide the suitable viscosity which allows a fast and homogeneous finish. For an optimal result, 360 g/m² of product applied in two passes or layers are applied. Said varnish application is performed in an environment with controlled humidity and temperature.

After applying the varnish and once it dries, respecting the waiting times for obtaining suitable solidification, hardness and glossiness of the protective varnish, the surface is sanded to improve its quality and to prepare for the last polishing step of the method. A Heesemann type machine is used for this sanding. For optimal sanding, the following sandpapers with different degrees of abrasiveness can be used, such as:
Type 1 800 grit aluminum oxide sandpaper
Type 2 1000 grit aluminum oxide sandpaper
Type 3 1500 grit aluminum oxide sandpaper

To achieve a homogeneous and uniform polishing it is considered that the displacement rate must be 6 ml/min. In the process of sanding with a machine and for the purpose of preventing accumulations of material, impurities and adhered elements, this can be repeated several times by intercalating steps of sanding with aluminum oxide sandpaper having a different grit.

The last step of the method consists of polishing the visible surface to achieve a finer finish than that obtained with the preceding sanding, and in the specific example, it is done by means of a Bauerrichter type machine with a polishing capacity of 20 m² with a displacement rate of 3 ml/min. Polishing in this machine is by means of an abrasive polishing paste followed by a gloss. A coolant, preferably water, is used to prevent the heating of the protective varnish and the polishing tools. Specifically, in the present example, the polishing process comprises the steps of:
4 passes of polishing pastes,
4 passes of coolant, and
1 pass of gloss.

The product obtained by means of the preceding method therefore comprises a frame with a thickness of 10, 16 or 19 mm, a layer corresponding to an image printed on the frame and at least one layer of a varnish with a high solid content on the printed image.

Finally, given that the description corresponds to a preferred embodiment, it is understood that any modification or variation in detail that does not affect the essential features thereof and all the auxiliary and secondary elements may be variable, provided that the essential features of the improvements that have been described and as defined in the following claims are neither altered, changed nor modified.

1. A method for coating printed surfaces, characterized in that it comprises the following steps:
a) printing an image on the surface of a substrate,
b) applying at least one layer of a varnish product on the surface of the printed image,
c) sanding the preceding layer to eliminate accumulations of material, impurities and other unwanted adhered elements,
d) polishing the previously sanded layer to eliminate imperfections, and
e) glossing the surface to improve and enhance the glossiness thereof.

2. The method according to claim 1, characterized in that steps b) and c) are repeated on the surface after sanding it (b).

3. The method according to claim 1, characterized in that the varnish is applied by means of a microspraying process to prevent air bubbles and to obtain greater uniformity.

4. The method according to claim 1, characterized in that the applied varnish incorporates a catalyst and a diluent.

5. The method according to claim 1, characterized in that the varnish is a transparent varnish with a high solid content.

6. The method according to claim 1, characterized in that the different steps are performed in an automated manner by means of machines to achieve better and greater uniformity.

7. A coated printed surface, characterized in that it comprises a frame, a layer corresponding to a printed image on the frame and at least one layer of a varnish with a high solid content on the printed image.
